(19) United States
(12) Patent Application Publication
(10) Pub. No.: US 2023/0385686 A1
(43) Pub. Date: Nov. 30, 2023

(54) SYSTEM AND METHOD FOR INTEGRATED LARGE-SCALE AUDIENCE TARGETING VIA AUGMENTED HETEROGENEOUS SUBSYSTEMS

(71) Applicant: YAHOO ASSETS LLC, Dulles, VA (US)

(72) Inventors: Keqian Li, Jersey City, NJ (US); Yifan Hu, Mountain Lakes, NJ (US)

(21) Appl. No.: 17/827,364

(22) Filed: May 27, 2022

(51) Int. Cl. G06N 20/00

(52) U.S. Cl. CPC G06N 20/00

(57) ABSTRACT

The present teaching relates to method, system, medium, and implementations for integrated targeting. An expert hierarchy is constructed with an initial expert layer with multiple initial experts and one or more augmented expert layers with each augmented expert therein augments, via machine learning, experts at any lower layer of the expert hierarchy. A nonlinear integration model is obtained, via machine learning, for combining expert predictions from experts in the expert hierarch based on an input to generate an integrated expert prediction in response to the input.

### CROSS-REFERENCE TO RELATED APPLICATIONS

The present application is related to U.S. patent application Ser. No. _____ (Attorney Docket No. 146555.562795), entitled “SYSTEM AND METHOD FOR AUGMENTING EXISTING EXPERTS FOR ENHANCED PREDICTIONS” and U.S. patent application Ser. No. _____ (Attorney Docket No. 146555.562796), entitled “SYSTEM AND METHOD FOR INTEGRATING MULTIPLE EXPERT PREDICTIONS IN A NONLINEAR FRAMEWORK VIA LEARNING”, both of which are incorporated herein by reference in their entireties.

### BACKGROUND

### 1. Technical Field

The present teaching generally relates to machine learning. More specifically, the present teaching relates to integrating augmented predictions.

2. Technical Background

With the development of the Internet and the ubiquitous network connections, more and more commercial and social activities are conducted online. Digitized content is served or recommended to millions of online users. Advertising activities are also more and more shifted to online and ads are displayed to users while content is delivered to the users. To make online advertising more effective, targeting has been practiced. This includes targeting users from the perspective of advertisers and selecting appropriate ads for online users who may be interested in the content of the ads. Online advertising has played an important role in continued growth in many industries. To continue the growth in online advertising, content customization has been practiced which allows online advertisers and other parties participating in online advertising to effectively target/budget/schedule/display ad budget and delivery operations to maximize the gains. A typical task in targeting is to, given a user and one or more predefined groups or segments, assign the user to a corresponding user segment based on available user's online activities and possibly existing membership between users and user segments. An effective solution to this commonly faced issue in online information exchange usually has a significant social and economic impact.

In a user segmentation system, preferences of content consumers (end users) and advertisers may be identified either based on declared interests or learned from their activities or specifications. The ads may be ranked with respect to different consumers or consumer segments based on predicted outcome of displaying ads and recommendations are made according to the rankings. Large scale ranking and recommendation models may be specifically designed for particular type of prediction tasks. This type of approaches has drawbacks especially when the amount of possible prediction tasks is high. For example, task heterogeneity is an issue because digital footprints, such as users' online activities, may be logged and integrated from a wide range of contexts, platforms, and even physical machine types (heterogeneity) so that they may vary significantly in terms of modality and schema, making it hard for learning systems to adapt. Another issue has to do with the long-tailness of data, i.e., the fine granularity of segments used for information customization often results in extremely large numbers of prediction tasks, many of which belong to the long-tail of the distribution with insufficient signals or observations. As another example, data availability is also an issue, due to, sometimes, the missing at random (MAR) effects and, at other times, due to the restrictions imposed because of user privacy and regulation compliance considerations. As a consequence, a learning scheme that relies on adequate availability of training data may not be able to learn adequately.

Efforts have been made to address some of these issues. For example, to integrate heterogeneous systems, ensemble learning is used to leverage multiple machine learning models or commonly known as experts to achieve super learning. Such integration approaches are developed from the branch of statistics that employs machine learning models based on linear models such as regression model for combining predictions from individual experts into a final decision. However, due to the complexity of inter-relationships among data and different data sources, it is not possible to capture such inter-relationships via linear models. FIG. 1 (PRIOR ART) illustrates a typical framework of integrating multiple experts using a linear model. As shown, there are a plurality of trained experts (which could be homogeneous or heterogeneous experts), including expert 1 110-1, expert 2 110-2, . . . , expert k 110-k. When an input is provided to the experts, each of the experts outputs its expert output (EO), i.e., EO 1 120-1, EO 2 120-2, . . . , EO k 120-k. To combine these experts' opinions into a final output, prior art integration models usually use a linear combination of the individual experts' outputs or use a weighted sum of the individual outputs from different experts as the final output. As illustrated in FIG. 1A, EO 1 120-1 from expert 1 110-1 is weighed using W1 130-1, EO 2 120-2 from expert 2 110-2 is weighed using W2 130-2, . . . , EO k 120-k from expert k 110-k is weighed using Wk 130-k. The linear integrator 140 generates an integrated expert output, which is a combination expressed as W1*EO 1+W2*EO 2+ . . . +Wk*EO k, where in general W1+W2+ . . . Wk=1.0.

In this kind of scheme, each of the individual experts may learn knowledge that can be learned from their own training data from a limited setting without being able to leveraging the relationships among the experts and the data used for training. This is particularly so when the experts are heterogeneous. In addition, each expert system may be designed in some way given the local circumstances so that they learn only from such perspectives without more or without being able to leveraging the knowledge from other experts. Given that, linearly combining their outputs using a linear combination cannot capture the actuality of the world.

Thus, there is a need for solutions that address the challenges discussed above and enhance the performance of segment prediction for targeting.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to integrated targeting. An expert hierarchy is constructed with an initial expert layer with multiple initial experts and one or more augmented expert layers with each augmented expert therein augments, via machine learning, experts at any lower layer of the expert hierarchy. A nonlinear integration model is obtained, via machine learning, for combining expert predictions from experts in the expert hierarch based on an input to generate an integrated expert prediction in response to the input.

In a different example, a system is disclosed for integrated targeting. The system includes an expert hierarchy and a nonlinear integration model. The expert hierarchy is configured to include an initial expert layer and one or more augmented expert layers, wherein the initial expert layer has a plurality of initial experts and an augmented expert layer has at least one augmented expert for prediction, an augmented expert augments, via machine learning, experts at any lower layer of the expert hierarchy. The nonlinear integration model is obtained via machine learning and configured for combining expert predictions from experts in the expert hierarch based on an input to generate an integrated expert prediction in response to the input.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for integrated targeting. The information, when read by the machine, causes the machine to perform various steps. An expert hierarchy is constructed with an initial expert layer with multiple initial experts and one or more augmented expert layers with each augmented expert therein augments, via machine learning, experts at any lower layer of the expert hierarchy. A nonlinear integration model is obtained, via machine learning, for combining expert predictions from experts in the expert hierarch based on an input to generate an integrated expert prediction in response to the input.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 (PRIOR ART) depicts a traditional linear integration scheme of combining multiple experts;

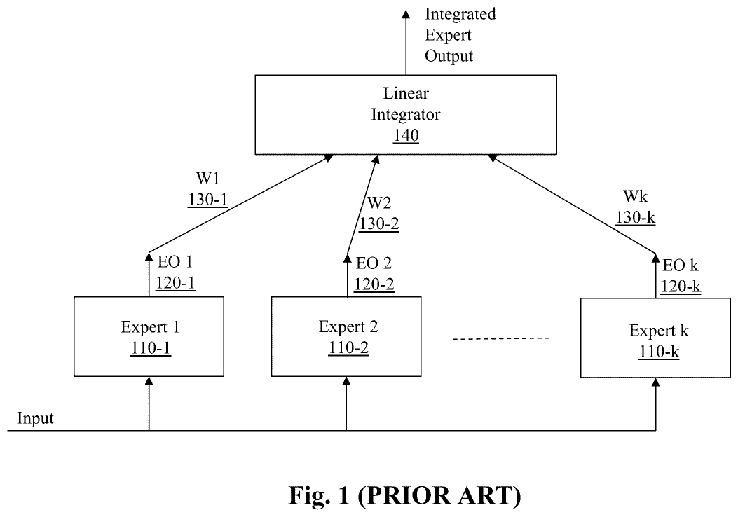

FIG. 2A depicts an exemplary high level system framework for augmented experts learning and nonlinear integration of heterogeneous experts, in accordance with an embodiment of the present teaching;

FIG. 2B is a flowchart of an exemplary process for augmented experts learning and nonlinear integration of heterogeneous experts, in accordance with an embodiment of the present teaching;

FIG. 2C depicts an exemplary implementation of a non-linear heterogeneous expert integration module, in accordance with an embodiment of the present teaching;

FIG. 2D illustrates an exemplary nonlinear expert integration model, in accordance with an embodiment of the present teaching;

FIG. 3A depicts an exemplary architecture with one augmented layer for augmented expert learning with two experts, in accordance with an embodiment of the present teaching;

FIG. 3B depicts an exemplary architecture with one augmented layer for augmented expert learning with three experts, in accordance with an embodiment of the present teaching;

FIG. 3C illustrates the cross-layer connections among experts in an augmented expert learning architecture, in accordance with an embodiment of the present teaching;

FIG. 3D is a flowchart of an exemplary process for expert learning at both initial expert layer and the augmented layers, in accordance with an embodiment of the present teaching;

FIG. 4A depicts an exemplary high level system framework for augmented experts learning and integration of heterogeneous experts using a neural network, in accordance with an exemplary embodiment of the present teaching;

FIG. 4B illustrates exemplary types of learnable parameters of a neural network trained for nonlinear integration of heterogeneous experts, in accordance with an embodiment of the present teaching;

FIG. 5A depicts an exemplary high level system diagram for training a heterogeneous expert integration neural network for nonlinear integration of heterogeneous experts, in accordance with an exemplary embodiment of the present teaching;

FIG. 5B is a flowchart of an exemplary process for training a heterogeneous expert integration neural network for nonlinear integration of heterogeneous experts, in accordance with an exemplary embodiment of the present teaching;

FIG. 6 shows an architecture where expert outputs from trained experts are combined using an ANN trained to embed a nonlinear function for integrating expert outputs, according to an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses solutions that address challenges in the art. To resolve the issues associated with task heterogeneity, data long-tailness, and data availability in predicting based on online data, the present teaching presents a scheme of augmenting experts at one or more levels to not only leverage the learned expertise from original experts but also expand the expertise in terms of aspects of knowledge not yet learned by the existing experts including inter-relationships among existing experts that the traditional systems completely ignore.

To achieve that, in deriving a new augmented expert, in addition to training data, the outputs from previously trained experts (including original and previously augmented experts) are also used to train the new augmented expert, where the outputs from the previously trained experts are generated by these experts based on the same training data. The disclosed expert augmentation scheme yields heterogeneous experts which form an expert hierarchy. This expert hierarchy provides an expanded range of knowledge learned by different experts so that their respective expertise on the same task may be integrated to enhance the quality of the prediction as compared with the traditional systems.

The present teaching also discloses a nonlinear framework for integrating outputs from different experts to overcome the deficiencies of the traditional approaches that use linear weighted sum in integrating different experts. The present teaching presents a scheme of combining multiple experts in a nonlinear manner via learning. The multiple experts being combined using the scheme as disclosed herein may include homogeneous and/or heterogeneous experts. In some embodiments, the experts being combined may include conventional experts and/or augmented experts created based on some given existing experts using the augmentation scheme as disclosed herein. In some embodiments, an artificial neural network (ANN) is employed for integration so that embeddings of the ANN may be learned to capture the nonlinear complex relationships and serve as a nonlinear integration function for combining multiple expert outputs. Such a trained ANN with learned embeddings, when receiving outputs from multiple experts as input, yields an integrated expert via complex non-linear function learned and implicitly specified via the parameterized ANN.

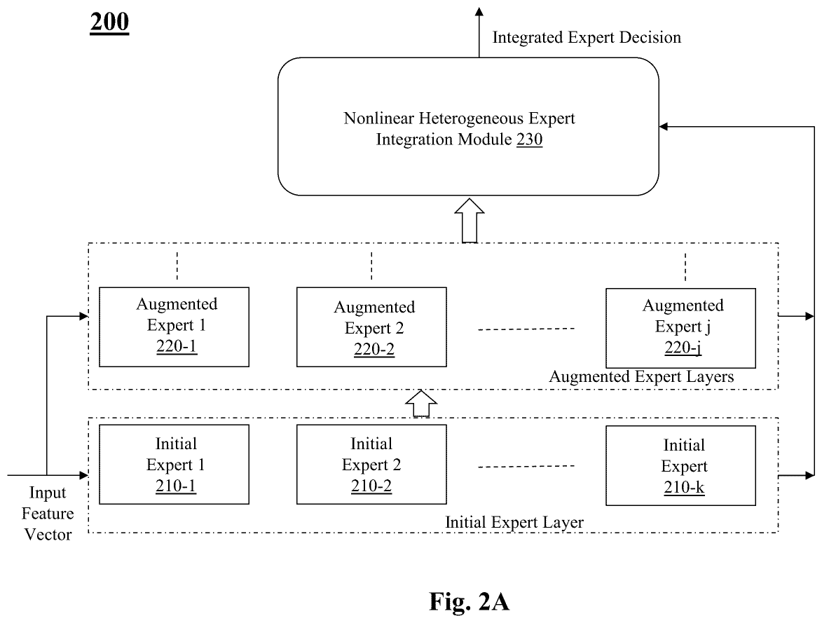

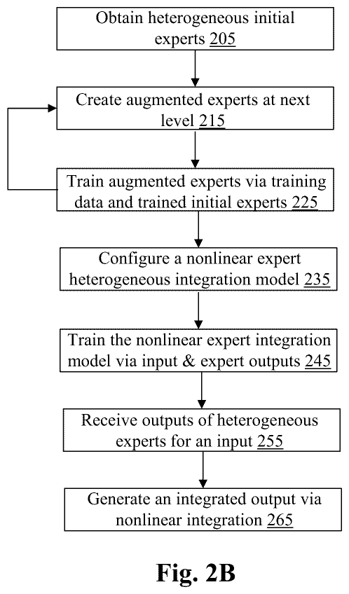

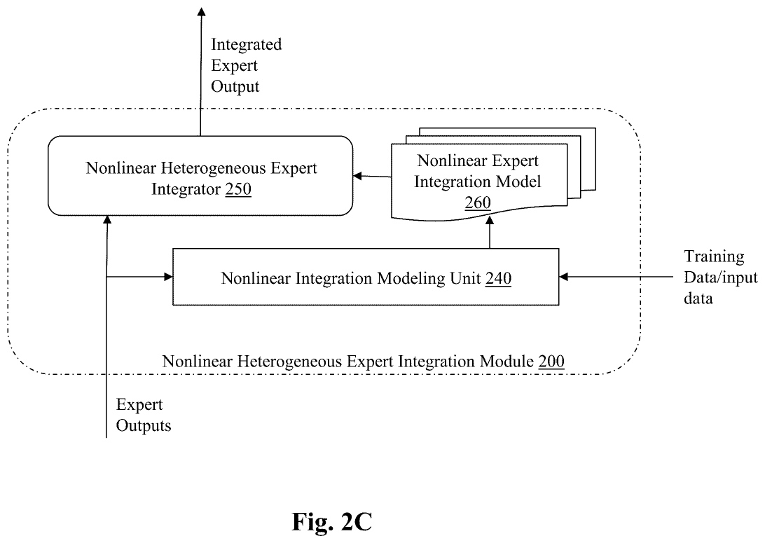

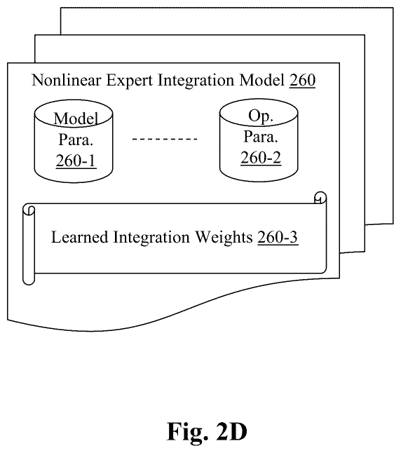

FIG. 2A depicts an exemplary high level system framework 200 for augmented experts learning and nonlinear integration of heterogeneous experts, in accordance with an embodiment of the present teaching. In this illustrated framework 200, there are multiple layers (210 and 220) of experts that are integrated at an integration layer 230 to produce an integrated expert decision. The expert layers include an initial expert layer 210 and one or more layers 220 of augmented experts. The initial expert layer 210 may include a plurality of experts, including initial expert 1 210-1, initial expert 2 210-2, . . . , initial expert k 210-3. The initial experts may be homogeneous or heterogeneous and they can be used to generate augmented experts. The augmented experts may be created for different reasons. For example, different augmented expert may be represented using different models (e.g., linear or nonlinear), with different converging conditions (e.g., some have more lenient converging conditions than others), different initialization conditions, or different risk functions to be minimized during training.

Augmented experts in the augmented expert layers 220 may be organized as multiple layers. Augmented experts at each layer may be created at a separate time. For instance, augmented expert 1 220-1, augmented expert 2 220-2, . . . , augmented expert j 220-j may be at the first augmented expert layer 1 and are created via learning from both training data and by leveraging the expertise of previously trained experts at the initial expert layer 210. In this case, the original experts from the initial expert layer 210 constitute the base experts in creating each of the augmented experts 2210-1, 220-2, . . . , 220-j. Augmented experts at the next higher level in the augmented expert layers 220 may be further created by augmenting based on, e.g., the initial experts in the initial expert layer 210 as well as the augmented expert 1 220-1, augmented expert 2 220-2, . . . , and augmented expert j 220-j, etc. In this manner, augmented experts incorporate the expertise from all or part of the (base) experts at lower levels and their creation may be based on both the training data as well as the knowledge learned by lower-level experts via outputs from such base experts generated based on the same training data.

Once the expert hierarchy is created via iterative augmentation, the experts in the hierarchy are connected in such a manner to facilitate nonlinear integration of expert outputs to generate, based on an input feature vector, an integrated expert prediction decision. These layers of experts form an expert hierarchy, in which each expert's output may be connected to the input of every expert at higher levels. When an input feature vector is received by the experts in the hierarchy, each may generate its output not only based on the given input and the previously trained models, as conventional approaches, but also by considering the expertise of other experts at lower levels in the system, i.e., taking outputs from experts from lower expert levels as input. As shown in FIG. 2A, outputs of all experts from different levels are combined by the nonlinear heterogeneous expert integration module 230 to generate the integrated expert decision.

The framework of 200 addresses the deficiencies of the traditional approaches by introducing the mechanism of creating augmented experts so that additional dimension of expertise may be expanded, and the experts can be enriched. The augmentation is carried out hierarchically so that knowledge may be deepened with each level of augmentation. Through this mechanism, the expansion can be extended vertically with the layers, the complementary and interactive relationships among experts at the same level may be leveraged. Integrating expertise of different experts is in general not a simplistic linear combination. To overcome this deficiency of the prior art, the present teaching employs a nonlinear approach to model the complex relationships among different experts to learn the embedded interactions among experts and their expertise.

FIG. 2B is a flowchart of an exemplary overall process of the framework 200 for augmented experts learning and nonlinear integration of heterogeneous experts, in accordance with an embodiment of the present teaching. The operation includes the stages of augmenting experts, training of nonlinear integration model, and the operation of generating an integrated expert output based on outputs from all original and augmented experts. Initial experts may be previously trained elsewhere and received at 205 or trained at 205, which form the initial basis for creating augmented experts to generate the expert hierarchy. As discussed herein, layers of augmented experts may be created as a hierarchy in an iterative process. At each augmented layer, each augmented expert may be created, at 215, by, e.g., configuring a parametric model for the augmented expert and setting the initial parameters of the model before training. The configured models for the augmented experts are trained, at 225, based on training data and the outputs of the initial experts and previously trained augmented experts generated based on the same training data. Thus, the augmented experts are not merely additional experts but rather experts that are built on top of all previously experts. The steps of 215 and 225 are repeated to generate augmented experts at different levels of the expert hierarchy (210 and 220).

The number of augmentation levels and the number of augmented experts at each of the augmented levels may be controlled based on different criteria in accordance with, e.g., needs of specific applications. For instance, to ensure the dynamic coverage of the learning, the augmentation of the experts in the hierarchy may be developed along multiple directions by varying, e.g., model parameters, ways to initialize model parameters, cost functions, converging criteria, etc. and can be set up when each of the augmented experts is created.

Once the expert hierarchy is built, i.e., all the experts, including the original and the augmented experts, are all trained and ready to be used, it can be used for making predictions as they are trained for. As discussed herein, when an input, e.g., a feature vector, is received by the expert hierarchy, the input is sent to all experts in the hierarchy and each expert may then act on the input and generate its respective output. Some of the expert outputs are further sent to augmented experts at a higher level as additional input to these augmented experts so that augmented experts in the hierarchy also generate their respective outputs based on outputs of other experts. These multiple expert outputs are further combined to generate an integrated expert output as the integrated expert prediction of the expert hierarchy. To facilitate the integration, a nonlinear expert heterogeneous integration model is trained first. To do so, it is configured, at 235, prior to its training. To train this nonlinear expert integration model, input training data is used together with the outputs from experts in the hierarchy and during the training, the model parameters or embeddings are adjusted or trained, at 245, by learning from the discrepancies between the ground truth from the training data as well as the integrated expert outputs using the current model parameters. Once the nonlinear integration model converges via learning, when outputs from experts (generated based on given input feature vector) in the hierarchy are received, at 255, the trained nonlinear heterogeneous expert integration model is used to combine the outputs from the experts in the hierarchy to generate, at 265, an integrated output.

As discussed herein, experts in the expert hierarchy, once trained, may be used to carry out the tasks that they are trained to perform. Outputs from the experts are then integrated so that all experts' opinions can be leveraged to derive a more reliable integrated expert prediction. FIG. 2C depicts an exemplary high-level architecture of the non-linear heterogeneous expert integration module 230, in accordance with an embodiment of the present teaching. In this illustrated embodiment, the nonlinear heterogeneous expert integration module 230 includes a nonlinear integration modeling unit 240, a nonlinear expert integration model 260, and a nonlinear heterogeneous expert integrator 250. The nonlinear integration modeling unit 240 is provided for obtaining the nonlinear expert integration model 260, e.g., via learning based on training data, which is used, once trained, by the nonlinear heterogeneous expert integrator 250 to integrate expert outputs to derive the integrated expert output. The nonlinear expert integration model 260 corresponds to a nonlinear function trained to map outputs from experts to its own output or the integrated expert output.

FIG. 2D illustrates an exemplary content of the nonlinear expert integration model 260, in accordance with an embodiment of the present teaching. In some embodiments, the nonlinear expert integration model 260 is implemented as a parametric nonlinear function and during training, the parameters associated with the nonlinear expert integration model are learned. Such parameters may include, for example as shown in FIG. 2D, model parameters 260-1, . . . , operational parameters 260-2, as well as learned integration weights 260-3. If a neural network is employed to represent the model, the model parameters 260-1 may correspond to, e.g., configuration of the model such as the architecture (e.g., a neural network), parameters specifying the architecture of the model (e.g., a number of layers and connections between layers), etc. The operational parameters 260-2 may include initialization scheme used in learning, the loss function to be used to control learning, parameters specified with respect to the convergence conditions, etc. Most relevantly, the integration weights 260-3 are not the conventional weights that are linearly applied to outputs of expert outputs in order to linearly combine them. According to the present teaching, the learned integration weights 260-3 include parameters or embeddings of the neural network that can be learned during training and the learned integration parameters 260-3 form a nonlinear function for mapping, nonlinearly, expert outputs to a single output as the integrated expert prediction.

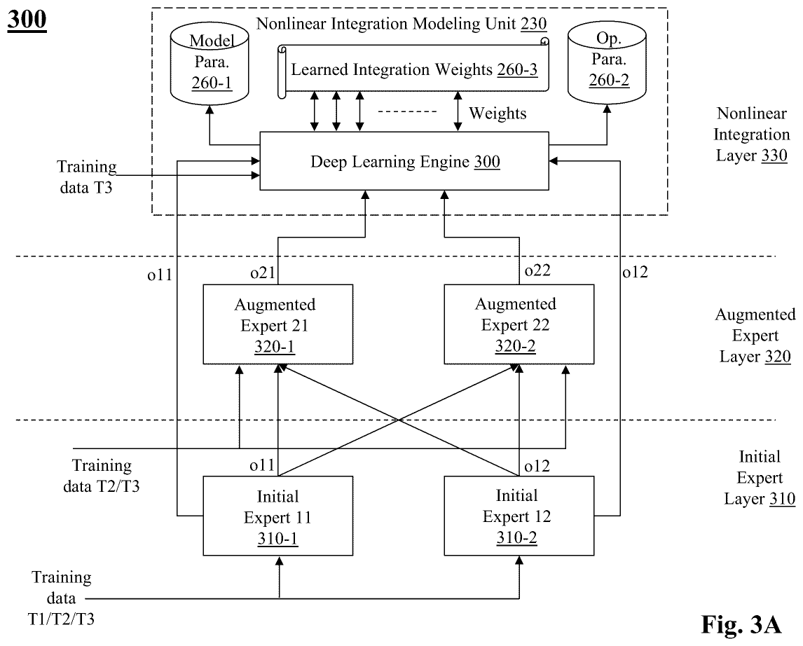

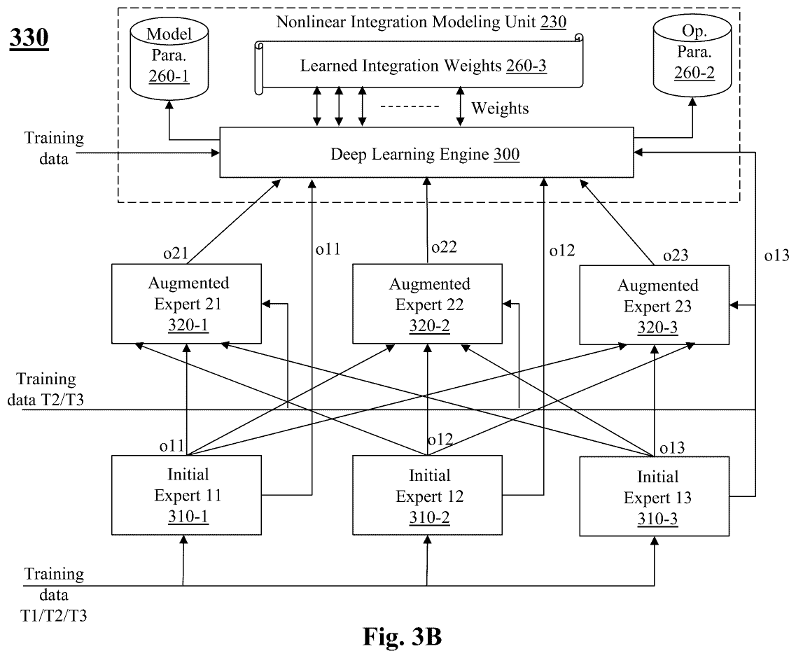

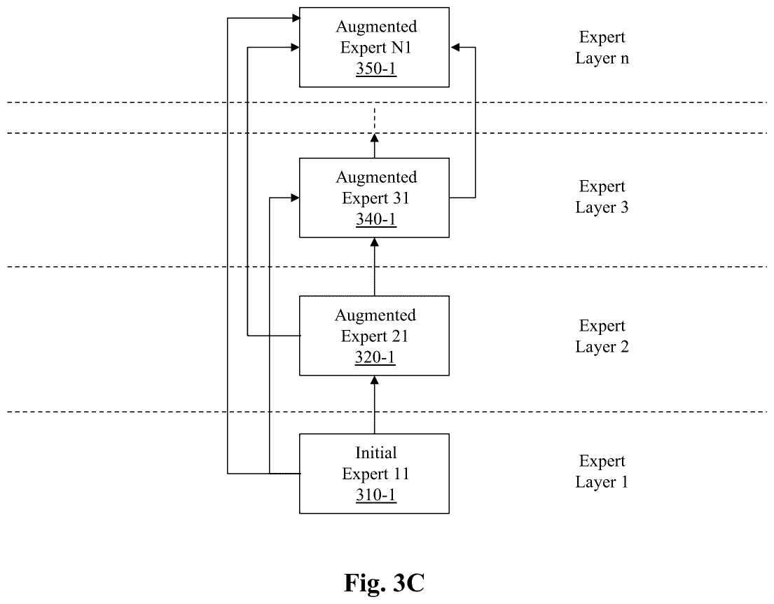

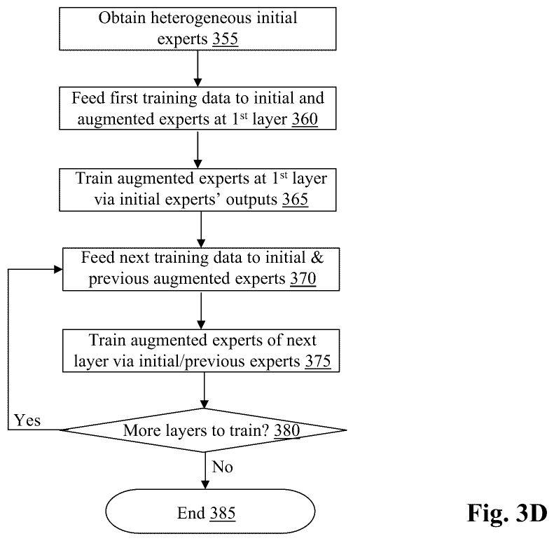

FIG. 3A depicts an exemplary architecture 300 with one augmented expert layer with two augmented experts during augmented expert learning, in accordance with an embodiment of the present teaching. In this illustrated example, there includes an initial expert layer 310, an augmented expert layer 320, and a nonlinear integration layer. The initial expert layer 310 includes in this example two initial experts, expert 11 310-1 and an initial expert 12 310-2. The augmented expert layer 320 includes two augmented experts augmented expert 21 320-1 and augmented expert 22 320-2, both of them are augmented based on the initial experts 310-1 and 310-2. In operation, the initial experts 310-1 and 310-2 are trained first using, e.g., training data set T1. In some embodiments, the initial experts may be heterogeneous, e.g., one may be an expert trained with linear regression and the other may be trained as a decision tree. Once the initial experts are trained, they may be used to create augmented experts.

In the illustrated example, to develop the augmented expert at augmented expert layer 320, training data set T2 is used for training the augmented experts 320-1 and 320-2. In creating the augmented experts 320-1 and 320-2, the trained initial experts 310-1 and 310-2 are used to generate their respect output (expert outputs) based on the same training data from T2. That is, training data T2 is fed to both initial expert layer 310 and augmented expert layer 320 for training the augmented experts 320-1 and 320-2. As discussed herein, the augmented experts are trained by leveraging the expertise of the initial experts 310-1 and 310-2 so that the augmented experts are more refined. To achieve that, the training data in T2 are also provided to the initial experts 310-1 and 310-2 so that they produce expert outputs o11 and o12, both of which are fed to the augmented experts 320-1 and 320-2 as input. That is, the training of augmented experts 320-1 and 320-2 are based on both input from the training data T2 as well as the input expert outputs from the initial experts. As shown, the initial expert outputs o11 and o12 are sent to as inputs to both the augmented expert 21 320-1 and augmented expert 22 320-2 so that the augmented experts are learned in consideration of the expertise of the initial experts in a manner that is enhanced further in light of what the initial experts can achieve. The exemplary formal formulation to generating augmented experts is provided in detail below.

With training data set T2, the augmented experts 21 and 22 are trained. In this exemplary architecture with two layers of experts, once the training of augmented experts 21 320-1 and 22 320-2 are completed, the nonlinear integration modeling unit 240 may be trained based on training data T3. The training data in T3 is sent to all experts in the expert hierarchy, i.e., initial experts 11 310-1 and initial expert 12 310-2 as well as augmented expert 21 320-1 and augmented expert 22 320-2. These trained experts, reacting to the training data in T3, generate their respective expert outputs, i.e., o11 from initial expert 11 310-1, o12 from initial expert 12 310-2, o21 from augmented expert 21 320-1 and o22 from augmented expert 22 320-2. Note that the expert outputs oil and o12 from the initial experts 310-1 and 310-2 are also sent to the augmented expert 21 320-1 and 22 320-2 as inputs. All these expert outputs are then all sent to the nonlinear integration modeling unit 240 so that the nonlinear expert integration model 260 can be trained, as shown in FIG. 3A.

The nonlinear integration modeling unit 240 is provided for training the nonlinear expert integration model 260. In some embodiments, the modeling unit 240 includes a deep learning engine 300 that takes input data (including training data T3 as well as expert outputs o11, o12, o21, and o22 generated based on the same training data T3) and learns various parameters that define the nonlinear expert integration model 260 by adjusting these parameters during training to minimize some define loss function. During learning, the current weights in the learned integration weights 260-3 that implicitly define a nonlinear integration function for combining the expert outputs are used by the deep learning engine 300 to combine the expert output to come up with an integrated prediction. Such a combined integrated prediction is compared with the ground truth prediction provided by the trained data in T3. The discrepancy is used to determine how to adjust the current weight stored in 260-3 to minimize the loss. The process repeats until a convergence condition define in the operational parameters 260-2 is satisfied. As discussed herein, in some embodiments, the learnable parameters during training may include embedding parameters of the neural network (nonlinear integration weights 260-3). In some embodiments, the learning may also be conducted to learn other parameters such as model parameters 260-1 and operational parameters 260-2. The exemplary formal formulation in terms of learning the nonlinear integration model for combining expert output is provided in detail below.

FIG. 3B depicts another exemplary architecture 330 with an expert hierarchy with one augmented layer for three augmented experts, in accordance with an embodiment of the present teaching. Compared with the illustrated embodiment in FIG. 3A, the framework 330 has, at each level of the expert hierarchy, three (instead of two) experts. That is, there are three original experts at the initial expert layer 310 (i.e., initial expert 11 310-1, initial expert 12 310-2, and initial expert 13 310-3) and three augmented experts at the augmented expert layer 320 (i.e., augmented expert 21 320-1, augmented expert 22 320-2, and augmented expert 23 320-3). This example shows that when the number of experts increases, the connections to the higher-level experts may remain to be full, i.e., all expert outputs from the initial expert layer are provided to all augmented experts as input in order for developing augmented experts in a manner that fully leverage the expertise of the lower-level experts.

FIG. 3C illustrates exemplary cross-layer connections among experts at different layers of the expert hierarchy, in accordance with an embodiment of the present teaching. This example is provided with experts at different levels in a single vertical direction, i.e., for each level only one expert is shown without showing the connections from other experts at the same level. As seen in FIG. 3C, there are n layers in the expert hierarchy and one expert is illustrated at each layer. As discussed herein, the initial expert 11 310-1 at the initial expert layer is trained first using training data. Once it is trained, it is used as an expert to produce its output based on additional training data and its output is used for training augmented experts at higher levels. As seen in FIG. 3C, the output of initial expert 11 is sent to all augmented experts at all higher layers, including augmented expert 21 320-1, augmented expert 31 340-1, . . . , and all the way to the augmented expert N1 350-1 at layer n. In a similar way, the output of augmented expert 21 320-1 is sent to all augmented experts at higher layers, including augmented expert 31 340-1, . . . , all the way to augmented expert N1 350-1, and the output of augmented expert 31 340-1 is sent to all augmented experts at layer above it.

As discussed herein, in some embodiments, experts in the hierarchy are trained one layer at a time. That is, the initial experts may be trained first. When the initial experts are trained, they are used in training augmented experts at the next layer. For example, in FIG. 3C, when training augmented expert 21 320-1, the trained initial expert 11 310-1 takes the same training data used for training the augmented expert 21 320-1 as input and produces its expert prediction which is provided to the augmented expert 21 320-1 as input to facilitate the learning. Once the augmented expert 21 is trained, both the initial expert 11 310-1 and augmented expert 21 320-1 are used in training augmented expert 31 340-1 by providing expert outputs thereto based on the training data used to train augmented expert 31 340-1, etc. So, the training of augmented expert N1 350-1 use training data as well as outputs from all experts, whether initial or augmented, from lower layers. In this manner, an augmented expert created at a certain layer not only learns from the training data used but also leverages the learned expertise from all lower-level experts.

To ensure augmented experts to learn or expand the expertise already learned by lower-level experts, different learning dynamics may be introduced. This may include using heterogeneous experts in diversified modalities, applying different initialization approaches, employing different loss functions, or controlling the learning process with different convergence conditions. In some embodiments, the parameters that can be learned by different experts via training may also vary. For instance, some experts may be trained using parameters initialized using random numbers. Some experts may be trained to learn initialized parameters. Although the example architectures depicted in FIGS. 3A and 3B have the same number of experts at different layers of the expert hierarchy, it is merely for illustration and not intended as limitation to the present teaching. Similarly, although examples show fully connected network across different layers, partially network connections among different layers may also be possible and they are still within the scope of the present teaching.

FIG. 3D is a flowchart of an exemplary process for expert learning at both initial expert layer and the augmented layers, in accordance with an embodiment of the present teaching. As discussed herein, initial experts may be obtained as trained or may be learned via training. In this exemplary process, initial experts are derived via learning, at 355, based on training data. Once the initial experts at the initial expert layer are trained, they are used for training augmented experts. Training data for training augmented experts at the first augmented expert layer are fed, at 360, to both the trained initial experts and the augmented experts at the first augmented expert layer. The trained initial experts generate outputs based on the training data which are used as input to the augmented experts, which are trained, at 365, based on both the training data as well as the outputs from the initial experts. The augmented experts are trained in an iterative learning process until the learning converges. At this point, the augmented experts at the first augmented expert layer may then be used in training augmented experts at the next layer.

To train the augmented experts at the next layer, training data for training augmented experts at the next augmented expert layer are fed, at 370, to both the previously trained experts (including the initial experts and the augmented experts at the first augmented expert layer) and the augmented experts at the next layer. The trained initial and augmented experts then generate outputs based on the training data and such outputs are used as input to the augmented experts at the next layer, which are trained, at 375, based on both the training data as well as the outputs from all previously trained experts. The augmented experts at this next layer are trained in an iterative learning process until the learning converges. If there are more layers, determined at 380, the steps of 370 and 375 are repeated until augmented experts of all layers are trained.

The above-described framework for developing an expert hierarchy of heterogeneous experts corresponds to a concept called SuperCone. This learning framework is general and is a unified approach that can be applied to all prediction tasks, such as user segmentation, performance prediction, etc. It builds the distributed concept representation to obtain a reliable representation of signals from outputs from heterogeneous experts and model each of the tasks by combining heterogeneous prediction models that may vary in architectures, learning methods, or ways employed to learn the prediction tasks. The framework as disclosed herein, can flexibly incorporate adaptive expert combination modules and deep representation learning module from original input to augmenting the heterogeneous experts. It is an end-to-end approach for jointly learning the heterogeneous experts and the expert combination module. In some embodiments, the problem of representation learning may be formulated via a meta-learning framework known as “learning to learning,” which focuses on the learning mechanism that gains experience and improves its performance over multiple learning episodes. In some embodiments, the meta-learning is applied, according to the present teaching, in the context of optimizing learning based on heterogeneous experts.

Below, the learning of experts in the SuperCone framework is formally defined in the context of meta learning. Solutions according to the present teaching are formally formulated with respect to the exemplary task of predicting user segmentation. With this framework, items of interest may be ingested from a variety of domains with a diverse range of knowledge enrichment, resulting in a heterogeneous information network of users and events, and existing segments, each with their schema, modality, and patterns of interconnection. Formally, in order to predict a particular segment, let [symbol] be the set of users (i.e., entity) for which segment prediction is to be performed, and [symbol] be the set of possible prediction labels. Assume to represent resulting unfolded concepts as a real-valued concept vector (\vec{c}ₛ) for each user s, with the index being the list of concept vocabulary (C), and value being the intensity of its association to corresponding concepts.

For clarity, the scenario for learning with homogeneous experts is first disclosed. Specifically, assume a particular expert hⱼ associated with a hypothesis space hⱼ⊆ [symbol] ^{C}→ [symbol] . Assume that the algorithm for training the expert corresponds to an efficient oracle θ*ⱼ(ω; [symbol] ) which may be used for obtaining trained experts based on a given dataset [symbol] and meta-parameter ω∈Ω, that controls how the models are learned such as model hyperparameters.

$${θ}_{j}^{*} ( ω ' ) {=}^{△} arg {min}_{{θ}_{j} ∈ {Θ}_{j}} ( {h}_{j} ( \cdot ; {θ}_{j} ) ) = {\sum }_{s ∈ 𝒟} {L}_{j} ( {h}_{j} ( {\vec{c}}_{s} ; {θ}_{j} ) , y ( s ) ) \qquad ( 1 )$$

where θⱼ is the set of learn-able parameters contained in the parameter space Φⱼ, and Lⱼ is the loss used for training hⱼ; e.g., the loss function used for back-propagation. The task of learning unfolded concept with homogeneous expert may utilize one such an oracle, which can be defined as follows.

DEFINITION 1 (UNFOLDED CONCEPT LEARNING WITH HOMOGENEOUS EXPERT).

Assuming the label function of interest y: [symbol] → [symbol] mapping each user to a label in [symbol] , a probability density of the entity q: S→[0,1], and a sampled dataset [symbol] , the task is to learn a model hⱼ∈Hⱼ, that minimizes the expected risk according to a given criterion L defined below:

$${minimize}_{ω} R ( {h}_{j} ( \cdot ; \cdot , ω ) ) {=}^{△} {𝔼}_{q} [ L ( {h}_{j} ( \cdot ; {θ}_{j}^{*} ( ω ; ) ) , y ( ( s ) ) ) ] = {\int }_{S} L ( {h}_{j} ( {\vec{c}}_{s} ; {θ}_{j}^{*} ( ω ; ) ) , y ( s ) ) q ( s ) ds$$

where θⱼ∈Φⱼ denotes the task specific parameter and ω∈Ω denotes the meta-parameter.

The formalization of the user segmentation problem can be considered as a meta-learning problem in a more general setting. Assuming a distribution over tasks [symbol] : [symbol] →[0,1], and a source (i.e. meta training) dataset of M tasks sampled from [symbol] , each containing a training set (i.e., support set for meta-learning) and a validation set (i.e., a query set in meta-learning) with non-overlapping i.i.d. samples drawn from instances distribution qⱼ of task Tⱼ, as [symbol] _{source} [symbol] { [symbol] _{source}^{train}^{^{(j)}}, [symbol] _{source}^{val}^{^{(j)}}}ⱼ₌₁^{M}. Likewise, a target dataset (i.e. meta test) is also assumed of Q tasks sampled from [symbol] , each containing a training set (i.e., a support set) and test set (i.e., a query set) with non-overlapping i.i.d. samples drawn from instances distribution qⱼ of task Tⱼ, as [symbol] _{target} [symbol] { [symbol] _{target}^{train}^{^{(j)}}, [symbol] _{target}^{val}^{^{(j)}}}ⱼ₌₁^{Q}. The goal is to obtain the “meta knowledge” in the form of ω from [symbol] _{source}, which may then be applied to improve the downstream performance in [symbol] _{target} by fine-tuning on each individual training set at meta-test time.

In learning heterogeneous experts, however, a source and a target set may not be separate. In some embodiments, the only requirement may be that one dataset [symbol] serve as the source dataset for meta-training and there is one target dataset for meta-test. It is assumed that each of the tasks j,j=1 . . . J, where the only difference between tasks is the particular expert hⱼ, is associated with a hypothesis space hⱼ⊆ [symbol] ^{C}43 [symbol] , a set of learn-able parameter θⱼ∈Θⱼ, and a training oracle θ*ⱼ(ω; [symbol] ) that satisfies Equation 1. The goal of meta-training is to obtain optimal generalization error on the single test target set.

In some embodiments, formally, it is assumed that all the available instances will be used as both the source and target set. Given a sample of data [symbol] [symbol] { [symbol] ^{train}, [symbol] ^{test}} drawn i.i.d from the instance distribution q(s), some or all of the instances from [symbol] ^{train} for training the individual experts hⱼ(·; θⱼ; ω) may be used, i.e., ( [symbol] _{source}^{train}^{^{(j)}}⊆ [symbol] ^{train}, [symbol] _{source}^{val}^{^{(j)}}⊆ [symbol] ^{train}, [symbol] _{source}^{train}^{^{(j)}}∩ [symbol] _{source}^{val}^{^{(j)}}=0). Likewise, the dataset used for meta-testing may consume some or all of the training instances, i.e., [symbol] _{source}^{train}^{^{(j)}}⊆ [symbol] ^{train}, j=1 . . . J., ...J. The goal is to learn a joint model based on the adapted experts on the target training set, θ*ⱼ(ω; [symbol] _{target}^{train}^{^{(j)}}) for j=1 . . . J, denoted as h(·;ω,{hⱼ(·;θ*ⱼ(ω; [symbol] _{target}^{train}^{^{(j)}}))}), to achieve the best generalization error.

Learning of heterogeneous experts may be formally defined as below. DEFINITION 2 (LEARNING UNFOLDED CONCEPT WITH HETEROGENEOUS EXPERTS). Assuming the label function of interest y: [symbol] → [symbol] , a sampled dataset [symbol] , a set of heterogeneous experts hⱼ with inner training oracle θ*ⱼ(ω; [symbol] ) for j=1 . . . J, the task is to learn a combined model h that minimize a given loss criteria L: [symbol] × [symbol] →

[symbol]

$$minimize {=}^{△} = {ℛ}^{{𝒟}^{test}} ( h ( \cdot ; {ω}^{*} , \{ {h}_{j} ( \cdot ; {θ}_{j}^{*} ( {ω}^{*} ; {target}_{train ( j )}^{} ) ) \} ) ) = {\sum }_{s ∈ {𝒟}^{test}} L ( ( h ( {\vec{c}}_{s} ; {ω}^{*} , \{ {h}_{j} ( \cdot ; {θ}_{j}^{*} ( {ω}^{*} ; {target}_{train ( j )}^{} ) ) \} ) , y ( s ) ) ) \qquad ( 2 )$$

which defines an objective function as what Equation (1) with respect to learning with homogeneous experts. That is,

$$s . t . {ω}^{*} = arg {min}_{ω} {L}^{meta} ( \{ {θ}_{j}^{*} ( ω , \cdot ) \vert j = 1 … J \} , ω , {train}^{} ) \qquad ( 3 )$$

where L^{meta} is a meta-loss to be specified by the meta-training procedure, e.g., the cross-entropy error of temporal difference error. The formulation as presented herein on unfolded concept learning with heterogeneous experts enhances the efficiency and scalable distributed machine learning yet retains the representation power.

The discussion below involves two parts. The first part involves the representation of a meta module. The second part has to do with an optimization procedure. In terms of representation of a meta module, Ω is used to denote a meta parameter space with respect to any given choice of Θⱼ of each of the individual experts Hⱼ. A solution space induced by meta parameter ω brings inductive bias to the downstream tasks and affects the efficiency of learning procedure of each task. In general, there are some key desired criteria in building a model for the task of user segmentation. For instance, one issue is related to task agnostic expertise modeling. The choice of Ω in general should allow flexibly modeling over a large variety of task types and best utilizing the power of experts from [symbol] ={Hⱼ|j=1 . . . J} in an adaptive way without task-specific engineering. Another issue is related to representation power, i.e., the choice of Ω should possess adequate representation capacity for inducing deep representation of data and not limit itself to specific features or classes of functions. Another example issue is on first order influence. The influence of meta parameter co over the learning mechanism should allow for efficient meta-optimization for performance-critical application, and not incurring higher order gradient computation when learning ω.

Traditional approaches mostly fall into the categories of traditional super learning and ensemble learning scheme that are heuristic in nature and fail to meet the second criterion stated above. Traditional deep learning approaches fail the first criterion because they do not incorporate the power of heterogeneous experts. Other existing meta-learning approaches rely on higher order and bi-level optimization so that they do not meet the third criterion. The expert augmentation as disclosed herein according to the present teaching, has a meta-learning architecture that constructs a large portfolio of augmented experts and learns deep representation for both direct prediction from unfolded concepts and indirect combination of heterogeneous experts. At the same time, each of the experts possesses its own respective individual prediction power and expertise learned in their training.

A sluice network for heterogeneous experts may be developed based on exemplary criteria as discussed below. Give a set of experts, an augmented set of experts [symbol] _{Aug} may be constructed by, e.g., enumerating nested combinations among the experts. For example, an augmented expert in [symbol] _{Aug} can be (1) any expert model with hypothesis space [symbol] belonging to initial experts [symbol] , (2) any arithmetic combination between an arbitrary number of experts in [symbol] _{Aug}, and (3) Any recursive application of an expert with hypothesis [symbol] belong to [symbol] _{Aug} over an arbitrary number of outputs from models from [symbol] _{Aug}. Such expert expansion may be implemented following the sluice network architecture, with, e.g., additional layer-by-layer skip connections. As discussed herein, the output at each level of densely connected experts σ(·) may be fed to both the immediate next level as input, as well as higher levels, and the subsequent connected layers henceforth.

To further augment the model capacity and obtain a deep representation of the data, a complementary expert module h_{comp} may be incorporated with hypothesis space H_{comp} that allows flexible modulation of information flow while respecting the simplicity of network design. To that end, the neural multi-mixture of experts' architecture may be adopted that learns an ensemble of individual experts in an end-to-end fashion. To achieve that, the neural net may be divided into an end output module Tower and inner expert neural submodules. The output module produces the output for a particular task in hand. All experts in the inner expert neural submodules are called InnerExpertₜ, 1≤t≤E. There may also be certain gating network Gateᵢ, that projects an input from the original data representation \vec{c}ₛ directly into [symbol] ^{E}. The prediction of the final complementary expert maps a concept vector representation \vec{c}ₛ into label space [symbol] , H_{comp}(\vec{c}ₛ), which can be expressed as:

$${h}_{Comp} ( {\vec{c}}_{s} ) = Tower ( {v}_{s} ) \qquad ( 4 )$$

$${v}_{s} = {\sum }_{t}^{E} ( softmax {( Gate ( {\vec{c}}_{s} ) )}_{( t )} \cdot Inner {Expert}_{t} ( {\vec{c}}_{s} ) ) \qquad ( 5 )$$

Here, the intermediate representation vₛ may corresponds to a weighted sum by a shallow network Gateᵢ(cₛ^{\vec{m}eta}) after normalizing into unit simplex via softmax(·). Each InnerExpertt, may then, in turn, correspond to an ensemble of sub-modules mapping \vec{c}ₛ to a fixed-length vector.

$$Inner {Expert}_{t} ( {\vec{c}}_{s} ) = {\sum }_{i = 0}^{L} {Depth}_{t , i} ( {\vec{c}}_{s} ) \qquad ( 6 )$$

Depth_{t,i}=Proj_{t,i}(Proj_{t,i-1}( . . . (Embed(\vec{c}ₛ) . . . ))) (7)

where Depth_{t,i} denotes an intermediate output of inner expert t at depth i, consisting of projection in the form of Proj_{t,i}, which may be implemented as a linear layer followed by a relu activation. In some embodiments, an ensemble of neural experts may first be combined to form a deep representation from the concept vector, and then further be combined with the rest of heterogeneous experts.

On combining different experts, the approaches as disclosed herein according to the present teaching is capable of adaptively weigh-in different predictions across experts. To achieve that, weights over individual candidates may be learned in an adaptive fashion based on a separate neural network component, denoted by, e.g., Comb(·), which may be implemented using an architecture similar to h_{comp}. Assuming experts from [symbol] _{Aug} are arranged as an array of mapping functions {h₁, h₂, . . . h [symbol] _{_{Aug}}}, Comb(·) may then be used to map the concept vector \vec{c}ₛ into a vector with dimension equal to | [symbol] _{Aug}|+1. The final model prediction, h(\vec{c}ₛ), may then be produced using an additional layer of weighted sums over all possible experts.

$$h ( {\vec{c}}_{s} ) = {\sum }_{t ∈ \{ 1 , 2 , … , T \} ⋃ \{ Aug \}} ( softmax ( {Comb ( {\vec{c}}_{s} )}_{( t )} \cdot {h}_{t} ( {\vec{c}}_{s} ) ) \qquad ( 8 )$$

As discussed herein, the learning process during meta learning is to learn or optimize meta-parameters ω, that are agnostic to the heterogeneous experts in [symbol] . Naive approach that directly treats the original input dataset D to compute the meta loss Lₘₑₜₐ, or using it as the support set [symbol] _{source}^{train(j)} might lead to “meta-overfit” where the combination network and the added experts from [symbol] _{Aug} may falsely rely on overfitted experts. To avoid such issues, the present teaching discloses a principled framework to construct a meta-training set that eliminates the phenomenon in general. The basic consideration is to extract non-overlapping subsets of the data as the support and query set as the source data meta-training to minimize the discrepancy between meta-training and deployment. Such an optimization scheme makes no assumptions about the heterogeneous experts, including the existence of gradients in its learning process.

According to this optimization scheme, each level of heterogeneous experts is trained recursively on previous levels with its own meta-training set based on the cross-validation split approach as discussed herein, with the final level corresponding to a super augmented expert hierarchy or architecture. Heterogeneous experts may be indexed by the depths that it depends on, e.g., with hⱼ^{(k)} denoting the jth expert at kth layer, k=1, 2, . . . , K. At each depth, a cross validation scheme may be adopted with, V^{(k)} mapping instance s from [symbol] ^{train} to a fold among 1, 2, . . . , V, and the learning proceeds by creating higher order meta-training datasets at each kth layer, [symbol] ^{train(k)} as:

[symbol]

^{train(k)} [symbol] {(xₛ^{{right arrow over (()}k)},zₛ^{{right arrow over (()}k)})|\vec{x}ₛ∈ [symbol] ^{train(k)}} (9)

xₓ^{{right arrow over (()}k)}₍ⱼ₎ [symbol] hⱼ^{(k)}(\vec{x}ₛ;θ*ⱼ(ω,( [symbol] ^{train(k-1)})^{˜s})) (10)

with ( [symbol] ^{train(k)})^{˜s} denoting the subset of ( [symbol] ^{train(i)}) not in the same fold as instance i, formally:

( [symbol] ^{train(k)})^{˜s} [symbol] {V^{(k)}ₛ)≠|V^{(k)}_{(s′)}|\vec{x}ₛ, ∈ [symbol] ^{train(k)}} (11)

Meta-parameter set ω is trained using the last layer of the constructed meta-training dataset [symbol] _{source}^{train} [symbol] [symbol] ^{train(K)}, with respect to the meta loss, which may be defined as follows:

$${L}^{meta} ( \{ {θ}_{j}^{*} ( ω , \cdot ) \vert j = 1 … J \} , ω , {𝒟}^{train} ) {=}^{△} {\sum }_{{\vec{x}}_{s} ∈ {source}_{train}^{}} L ( {h}^{train} ( {\vec{x}}_{s} ) , y ( s ) ) \qquad ( 12 )$$

with the meta-training time model h^{train}(\vec{x}ₛ) defined by replacing the output of all heterogeneous experts directly by taking all but the first |C| elements from the input, \vec{x}_{s[:|C|]} and feeding the alternative expert and the combination network with the original feature, \vec{x}_{s[:|C|]}. Formally,

$${h}^{train} ( \vec{x} ) {=}^{△} {\sum }_{t ∈ \{ 1 , 2 , … , T \} ⋃ \{ Aug \}} {v}_{s}^{t}$$

$${v}_{s}^{t} {=}^{△} ( {softmax ( Comb ( {\vec{x}}_{s [ : \vert C \vert ]} ) )}_{( t )} \cdot {( {h}_{alt} ( {\vec{x}}_{s [ : \vert C \vert ]} ) , {\vec{x}}_{s [ : \vert C \vert : \vert} )}_{( t )} \qquad ( 13 )$$

That is, in this illustrated embodiment, the learning of the network parameter is posed as an end-to-end optimization problem, which can be solved using efficient gradient based methods. At meta-test time, the source set for each of the heterogeneous experts hⱼ^{(k)}, [symbol] _{source}^{train(k,j)} is defined as the k-th higher order meta-training dataset, i.e. [symbol] _{source}^{train(k,j)} [symbol] [symbol] ^{train(k)}.

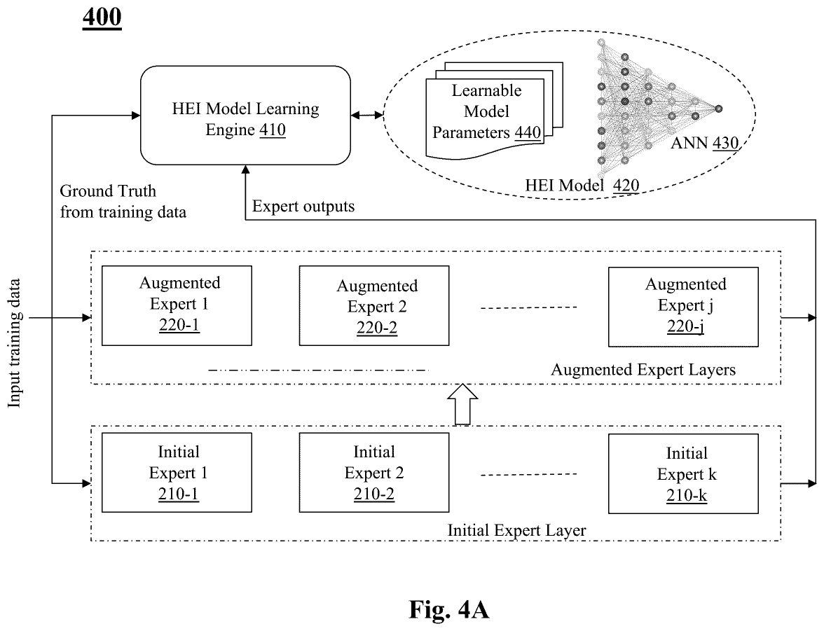

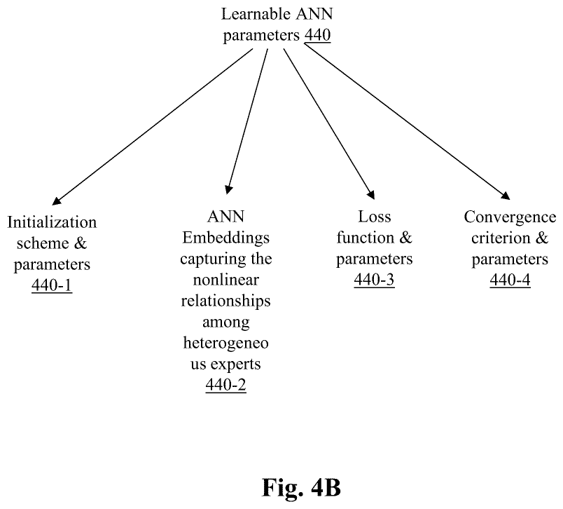

FIG. 4A depicts an exemplary high level system framework 400 for learning a nonlinear model 420 for integrating experts' outputs using a neural network, in accordance with an exemplary embodiment of the present teaching. In this framework 400, a heterogeneous expert integration (HEI) model 420 is represented using an artificial neural network (ANN) 430 which can be configured to operate via a set of learnable model parameters 440. Learning the HEI model 420 is to capture, via model parameters, complex (nonlinear) relationships/interactions among different experts. In this illustrated embodiment, the HEI model 420 is trained by a HEI model learning engine 410 via machine learning. During the training, a variety of learnable parameters 440 associated with the ANN 430 are learned based on training data with respect to the ground truth labels provided therein so that the ANN 430, once configured using the learned parameters 440, is capable of combining, in a nonlinear manner, outputs from individual experts to generate integrated expert decisions consistent with the knowledge learned from the training. The complex and nonlinear relationships and/or interactions among different individual experts are captured in the learned parameters embedded in the ANN 430.

In this illustrated embodiment, to learn learnable model parameters 440 of the HEI model 420, previously trained experts in the expert hierarchy (e.g., initial experts at layer 210 and all augmented experts at higher layers) take input training data (e.g., feature vectors) as input and generate their respective expert outputs (some experts need to generate their outputs based on expert outputs from experts from lower levels of the expert hierarchy). These expert outputs are then fed to the HEI model learning engine 410 as inputs. To learn the values of the learnable parameters 440, in each iteration, the HEI model learning engine 410 takes expert outputs from experts in the expert hierarchy and computes an integrated expert decision by integrating the input expert outputs using current learnable model parameters in 440. This is performed by the ANN 430 that is configured using the current values of the learnable model parameters in 440. This ANN generated integrated expert decision is then compared with the ground truth label corresponding to the training data to determine a discrepancy, if any. If the discrepancy warrants a modification (learning) to the current values of the learnable model parameters, the modifications to the learnable parameters are determined by minimizing some defined loss function determined based on the discrepancy. The iteration continues until the discrepancy meets some pre-defined convergence criterion. Upon convergence, the ANN 430 configured using converged learnable model parameters 440 constitute a learned HEI model 420, which can be used to combine expert outputs in a manner consistent with the knowledge learned from the training data.

FIG. 4B illustrates exemplary types of learnable parameters associated with the ANN 430, in accordance with an embodiment of the present teaching. In some embodiments, as shown in FIG. 4B, learnable parameters include both schemes to be used to do certain things and parameters that may be used to achieve the schemes. For example, each ANN and its related parameters may be initialized prior to, e.g., training. Alternative initialization parameters may be learnable 440-1. This may include learning both initialization schemes as well as the operational parameters associated with each scheme. For instance, initialization schemes may include initializing using random numbers or initialization using a constant value such as zero as an initialization parameter value. In another example, a learning process usually involves a loss function, which may be selected from multiple alternative loss function schemes or formulations. Using which of the alternative loss functions and their corresponding parameters 440-3 (e.g., coefficients, etc.) may be learned during learning. The initialization of the parameters involved in different alternative loss function may themselves also be learnable. In yet another example, a convergence criterion to be used to control the convergence of machine learning may also be learned. Accordingly, so are the values of associated operating parameters and their initialization thereof associated with each alternative convergence criterion 440-4. Each of the alternative convergence criterion may have its own parameters to set and/or to initialize. So, not only a choice of each scheme adopted may be learnable but also the parameters associated therewith.

An ANN is a network of neurons at different layers that are connected in some fashion to form some structure. As such, an ANN may be alternatively structured which accordingly determines the parameters involved in the architecture that can be learned during training so that the converged network that operates under these parameters in a manner consistent with the training data provided. Such parameters include weights on the connections connecting neurons as well as variables and constants associated with the node function(s) that each and different neurons perform. These are embeddings 440-2 of the ANN and are all embedded in the operation of the ANN and are learnable parameters.

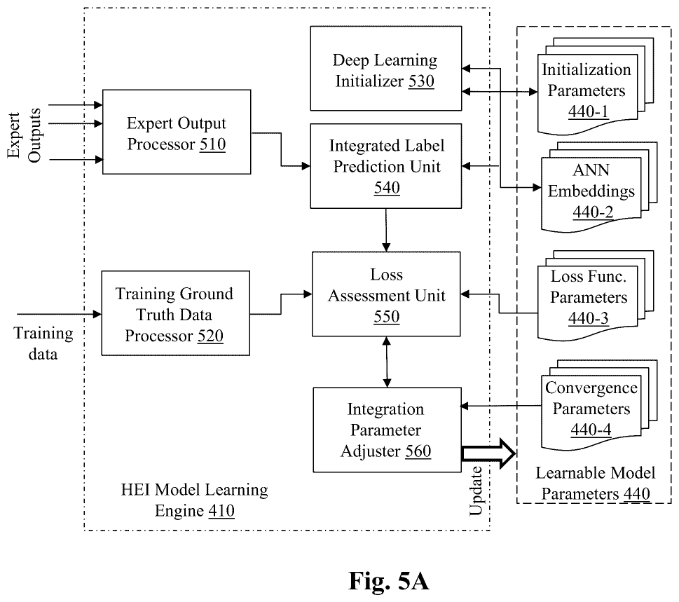

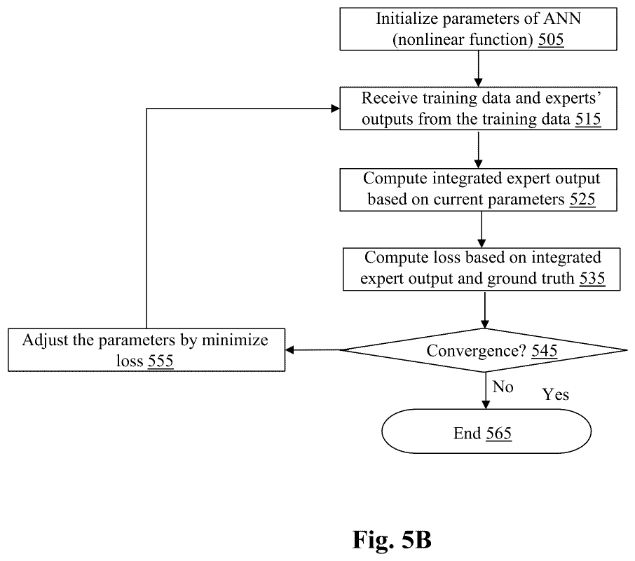

FIG. 5A depicts an exemplary high level system diagram for the HEI model learning engine 410 and its connections with the learnable model parameters 440, in accordance with an exemplary embodiment of the present teaching. In some embodiments, the HEI model learning engine 410 aims to learn the learnable model parameters in different categories, e.g., the ones illustrated in FIG. 4B, via training. In this illustrated example, the HEI model learning engine 410 comprises a deep learning initializer 530, an expert output processor 510, an integrated label prediction unit 540, a training ground truth data processor 520, a loss assessment unit 550, and an integration parameter adjuster 560. The HEI model learning engine 410 carries out a training process to learn a nonlinear function by learning the values of the learnable parameters 440. Once the parameters of the HEI model 420 are learned, the HEI model 420 represents a learned nonlinear function that maps its inputs, corresponding to the expert outputs from experts (including initial experts and augmented experts), to an output which corresponds to an integrated expert decision derived by combining the expert outputs using the learned nonlinear function.

FIG. 5B is a flowchart of an exemplary process for the HEI model learning engine 410, in accordance with an exemplary embodiment of the present teaching. In operation, to start a learning process to learn parameters of the HEI model 420 (which is a nonlinear function), the deep learning initializer 530 initializes, at 505, by assigning initial values to such parameters. As discussed herein, there are different types of model parameters, as illustrated in FIG. 4B, including embeddings of the ANN 430 such as initial weights on ANN network connections, initial values of coefficients of a loss function, etc. Based on the initialized model parameters, the iterative learning process begins. First, training data (e.g., feature vectors) is provided to all experts in the expert hierarchy as input so that each of the experts, whether original or augmented, generates a respective expert output, e.g., a predicted label. The expert outputs are then fed to the HEI model learning engine 410 as inputs for training the HEI model 420. This is shown in FIG. 5A, where the expert outputs are received, at 515, by the expert output processor 510 as input. For each piece of training data, based on which experts generate their respective expert outputs, it also includes a ground truth label, which is used by the HEI model learning engine 410 for learning.

As discussed herein, via learning, the HEI model learning engine 410 is to learn a non-linear function embedded in the HEI model 420 which can be used to map a set of expert outputs to an integrated expert decision. To facilitate the learning, the integrated label prediction unit 540 in the HEI model learning engine 410 combines, based on the current values of learnable model parameters (e.g., the values of the embeddings 440-2), the input expert outputs to generate, at 525, an integrated expert decision (or label). As discussed herein, each piece of training data includes a ground truth label, which serves as the ultimate answer as to the label and can be used to facilitate learning. That is, if there is a discrepancy between the ground truth label from the training data and the predicted integrated expert decision, a loss is computed, at 535, by the loss assessment unit 550 in accordance with the parameters related to the loss function (e.g., 440-3). The computed loss is then used to evaluate, at 545, whether the loss is such that it satisfies a convergence condition expressed by convergence parameters 440-4.

If the loss is such that there is a convergence, determined at 545, it may mean that the current values of learnable parameters in 440 are satisfactory to produce an integration result that can achieve substantially similar results as the training data. In this case, the learning process may end at 565. If otherwise, the integration parameter adjuster 560 updates, at 555, values of various learnable parameters to minimize the loss. In this scenario, the training enters into the next iteration based on a next piece of training data. In the next iteration, the updated values of the learnable parameters are then used to compute the integrated expert decision. The iterations may continue until the convergence condition is satisfied.

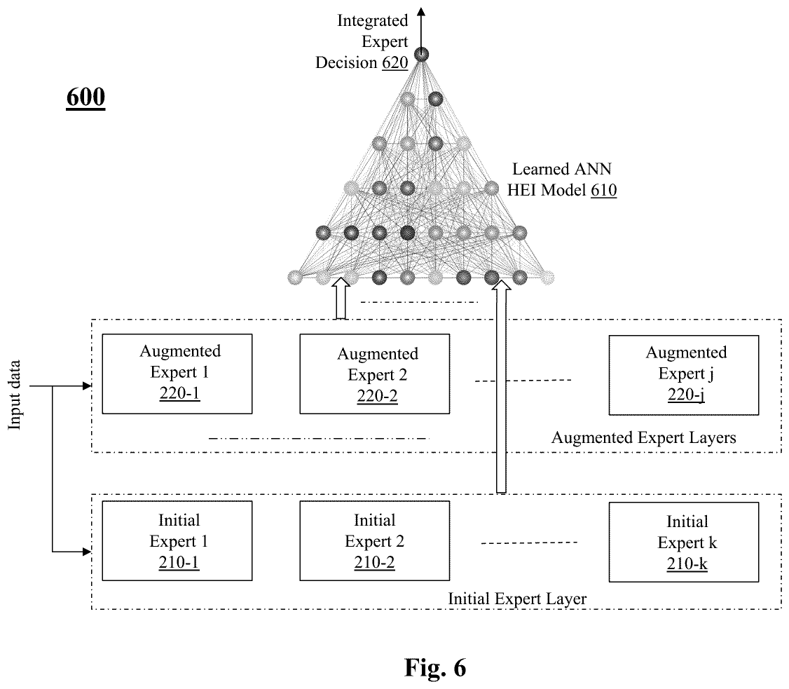

FIG. 6 shows an architecture 600 where expert outputs from trained experts, including original and augmented, can be combined using an ANN trained to embed a nonlinear function for integrating expert outputs, according to an embodiment of the present teaching. In this illustration, when input data is received, each of the experts in the expert hierarchy generates an expert output. Such expert outputs are then fed to a nonlinear mapping function 610, represented by the ANN model 460, that takes the expert outputs as input and generates, via the network with embeddings capturing the complex relationships/interactions among experts, an integrated expert decision 620.

Below, an exemplary algorithm implementation of training the original experts, generating, and training augmented experts, and learn the learnable parameters of the nonlinear integration parameters via an ANN architecture is disclosed:

Algorithm 1 SuperAug Algorithm

```
Require: label function of interest y: [symbol]   → [symbol]  , a sampled dataset [symbol] [symbol]     { [symbol]  ^{train}, [symbol]  ^{test}} with each
  instance associated with concept vocabulary C, heterogeneous experts hⱼ with inner training
  oracle θⱼ⁺ (ω; [symbol]  ) for j = 1 ... J
Require: K: maximum depth for constructing experts, V : number of possible values for cross
  validation scheme
```

| | |
|---|---|
| 1: | [symbol] ^{train(0)} ← [symbol] ^{train} |
| 2. | for all k ϵ {1 . . . K} do |
| 3: | for all s in [symbol] ^{train} do |
| 4: | V^{(k)} (s) ←random draw from {1 . . . V } |
| 5: | end for |
| 6: | construct [symbol] ^{train (k)} according to Equation 9, Equation 10 and Equation 11 |
| 7: | end for |
| 8: | obtain meta-trained ω* according to Equation 12 |
| 9: | for all k ϵ {0 . . . K} do |
| 10: | for all j ϵ {0 . . . J } do |
| 11: | adapt experts hⱼ^{(k)} h from support [symbol] _{target}^{train(k,j)} [symbol] [symbol] ^{train} according to Equation 1 |
| 12: | end for |
| 13: | end for |
| 14: | obtain final model based on the optimized meta parameter and adapted experts according to |
| | Equation 12 |

This exemplary implementation operates on the unfolded concepts. In this exemplary implementation, the meta-training set for experts from level 1 to level K is constructed in a, e.g., bottom-up progressive fashion following the cross-validation scheme (line 2-7), with the Kth layer of the meta-data-set for end-to-end training of meta parameters (line 8), the meta-testing time model can be obtained by adaptation on the support set (line 9-13) and combine the expert outputs according to the disclosed architecture (line 14). The above algorithm requires

$$O ( K \cdot J \cdot \frac{{n}_{experts}}{{n}_{meta}} ) + 1$$

times more computation cost compared to vanilla differentiable architecture training, with nₑₓₚₑᵣₜₛ/nₘₑₜₐ being the ratio of average training cost between heterogeneous experts and the differentiable architecture.

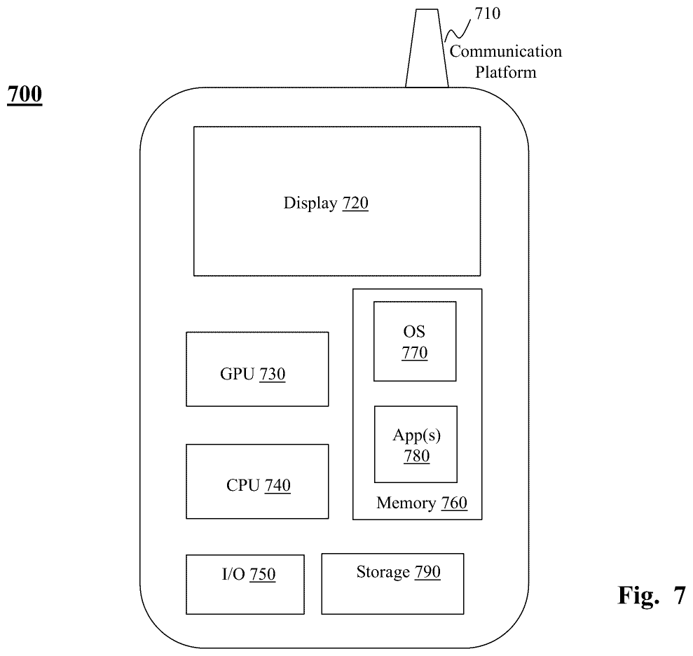

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 in order to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

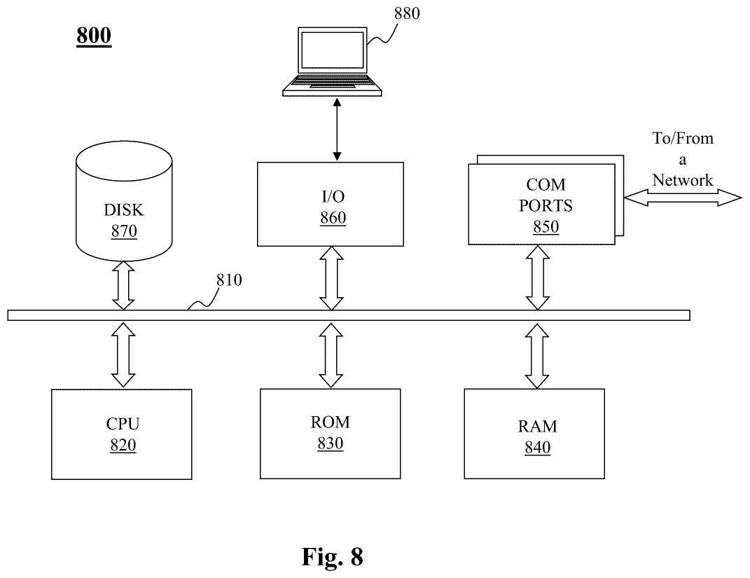

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for integrated targeting, comprising:
constructing an expert hierarchy comprising an initial expert layer and one or more augmented expert layers, wherein the initial expert layer has a plurality of initial experts and an augmented expert layer has at least one augmented expert for prediction, an augmented expert augments, via machine learning, experts at any lower layer of the expert hierarchy; and
obtaining a nonlinear integration model, via machine learning, for combining expert predictions from experts in the expert hierarch based on an input to generate an integrated expert prediction in response to the input.

2. The method of claim 1, wherein the initial experts of the initial expert layer are heterogeneous experts.

3. The method of claim 1, wherein an augmented expert at an augmented expert layer is derived by augmenting experts at any lower layer based on training data as well as predictions from experts at any lower layer based on the training data.

4. The method of claim 1, wherein the step of obtaining the nonlinear integration model comprises:
configuring the nonlinear integration model via a plurality of parameters; and
learning values of the plurality of parameters via machine learning to capture nonlinear relationships among the experts in the expert hierarchy.

5. The method of claim 4, wherein the nonlinear integration model corresponds to an artificial neural network (ANN) with the plurality of parameters related to the ANN, including embeddings of the ANN.

6. The method of claim 4, wherein the step of learning comprises:
initializing the values of the plurality of parameters;
receiving the training data having pairs of data, wherein each of the pair includes an input feature vector and a corresponding ground truth label; and
for each of the pairs in the training data,
receiving the outputs from the respective plurality of experts generated based on the input feature vector in the pair,
generating an integrated output of the received outputs based on current values of the plurality of parameters of the nonlinear function,
determining a loss based on a discrepancy between the integrated output and the ground truth label in the pair,
updating the current values of the plurality of parameter based on the loss, and
repeating the steps of receiving, generating, determining, and updating until a convergence condition is satisfied.

7. The method of claim 1, further comprising:
receiving the input;
sending the input to the experts at different layers of the expert hierarchy to facilitate each of the experts in the expert hierarchy to generate a prediction based on the input; and
combining, via the nonlinear integration model, predictions generated by the experts in the expert hierarchy to output an integrated expert prediction in response to the input.

8. Machine readable and non-transitory medium having information recorded thereon for integrated targeting, wherein the information, when read by the machine, causes the machine to perform steps of:
constructing an expert hierarchy comprising an initial expert layer and one or more augmented expert layers, wherein the initial expert layer has a plurality of initial experts and an augmented expert layer has at least one augmented expert for prediction, an augmented expert augments, via machine learning, experts at any lower layer of the expert hierarchy; and
obtaining a nonlinear integration model, via machine learning, for combining expert predictions from experts in the expert hierarch based on an input to generate an integrated expert prediction in response to the input.

9. The medium of claim 8, wherein the initial experts of the initial expert layer are heterogeneous experts.

10. The medium of claim 8, wherein an augmented expert at an augmented expert layer is derived by augmenting experts at any lower layer based on training data as well as predictions from experts at any lower layer based on the training data.

11. The medium of claim 8, wherein the step of obtaining the nonlinear integration model comprises:
configuring the nonlinear integration model via a plurality of parameters; and
learning values of the plurality of parameters via machine learning to capture nonlinear relationships among the experts in the expert hierarchy.

12. The medium of claim 11, wherein the nonlinear integration model corresponds to an artificial neural network (ANN) with the plurality of parameters related to the ANN, including embeddings of the ANN.

13. The medium of claim 11, wherein the step of learning comprises:
initializing the values of the plurality of parameters;
receiving the training data having pairs of data, wherein each of the pair includes an input feature vector and a corresponding ground truth label; and
for each of the pairs in the training data,
receiving the outputs from the respective plurality of experts generated based on the input feature vector in the pair,
generating an integrated output of the received outputs based on current values of the plurality of parameters of the nonlinear function,
determining a loss based on a discrepancy between the integrated output and the ground truth label in the pair,
updating the current values of the plurality of parameter based on the loss, and
repeating the steps of receiving, generating, determining, and updating until a convergence condition is satisfied.

14. The medium of claim 8, wherein the information, when read by the machine, further causes the machine to perform the steps of:
receiving the input;
sending the input to the experts at different layers of the expert hierarchy to facilitate each of the experts in the expert hierarchy to generate a prediction based on the input; and
combining, via the nonlinear integration model, predictions generated by the experts in the expert hierarchy to output an integrated expert prediction in response to the input.

15. A system for integrated targeting, comprising:
an expert hierarchy configured to include an initial expert layer and one or more augmented expert layers, wherein the initial expert layer has a plurality of initial experts and an augmented expert layer has at least one augmented expert for prediction, an augmented expert augments, via machine learning, experts at any lower layer of the expert hierarchy; and
a nonlinear integration model, obtained via machine learning, for combining expert predictions from experts in the expert hierarch based on an input to generate an integrated expert prediction in response to the input.

16. The system of claim 15, wherein the initial experts of the initial expert layer are heterogeneous experts.

17. The system of claim 15, wherein an augmented expert at an augmented expert layer is derived by augmenting experts at any lower layer based on training data as well as predictions from experts at any lower layer based on the training data.

18. The system of claim 15, further comprising a nonlinear integration modeling unit configured for training the nonlinear integration model by:
configuring the nonlinear integration model via a plurality of parameters; and
learning values of the plurality of parameters via machine learning to capture nonlinear relationships among the experts in the expert hierarchy.

19. The system of claim 18, wherein the nonlinear integration modeling unit carries out the step of learning by:
initializing the values of the plurality of parameters;
receiving the training data having pairs of data, wherein each of the pair includes an input feature vector and a corresponding ground truth label; and
for each of the pairs in the training data,
receiving the outputs from the respective plurality of experts generated based on the input feature vector in the pair,
generating an integrated output of the received outputs based on current values of the plurality of parameters of the nonlinear function,
determining a loss based on a discrepancy between the integrated output and the ground truth label in the pair,
updating the current values of the plurality of parameter based on the loss, and repeating the steps of receiving, generating, determining, and updating until a convergence condition is satisfied.

20. The system of claim 15, further comprising a nonlinear heterogeneous expert integrator, which is configured for:
receiving an expert prediction from each of the experts in the expert hierarchy generated based on the input; and
combining, via the nonlinear integration model, predictions generated by the experts in the expert hierarchy to output an integrated expert prediction in response to the input.
